(19) United States
(12) Patent Application Publication
(10) Pub. No.: US 2016/0332814 A1
(43) Pub. Date: Nov. 17, 2016

(54) WASTE MATERIAL PROCESSING SYSTEM HAVING ADJACENT AUGERS SEPARATED BY A DIVIDING WALL AND A RECIRCULATION CHUTE

(71) Applicant: Sustainable Alternative Feed Enterprises, Reno, NV (US)

(72) Inventors: Louis Anthony Pellegrini, Los Altos, CA (US); John Wesley Pastusek, Fort Worth, TX (US); Don Alan Arata, San Carlos, CA (US)

(21) Appl. No.: 15/174,622

(22) Filed: Jun. 6, 2016

Related U.S. Application Data
(63) Continuation-in-part of application No. 13/835,814, filed on Mar. 15, 2013, now Pat. No. 9,358,746.

(51) Int. Cl. B65F 3/24; B65F 3/22

(52) U.S. Cl. CPC B65F 3/24; B65F 3/22

(57) ABSTRACT

A container for the working and transportation of food product waste includes a shell configured for removable disposition within a refuse collection vehicle. The shell includes an opening for receiving product, and a cover for sealing the opening except when open to permit product to be added to container. The cover may be operably connected to a lift and invert mechanism on the refuse collection vehicle for coordinated operation. A working and transfer mechanism is disposed within the container to work food product waste prior to delivery of same to a processing facility, and to facilitate removal of the worked food product waste from the container through an output port of the container as part of the delivery of same. This mechanism has two or more augers each located in an adjacent trough with a dividing wall therebetween. A recirculation chute is located at an output end of the container.

### RELATED APPLICATIONS

The present application is a continuation-in-part of, and claims priority to U.S. patent application Ser. No. 13/835,814, entitled “COLLECTION AND PROCESSING CONTAINER CONFIGURED FOR REMOVABLE DISPOSITION WITHIN A REFUSE COLLECTION VEHICLE”, filed Mar. 15, 2013. The foregoing application is herein incorporated by reference in its entirety for all purposes.

### FIELD OF THE INVENTION

The present disclosure relates to systems for processing waste material.

### BACKGROUND

The present disclosure is related to refuse collection and recycling, and more specifically to a removably replaceable container for collection of food product waste which may be configured for partial processing of the food product waste during transit.

Modern refuse collection vehicles (e.g., garbage trucks) serve to collect relatively small quantities of trash or recyclables (collectively referred to herein as refuse) from collections points, compress collected refuse to extend the efficiency of the collection route, then deliver the refuse to one or more of a transfer station, recycling center, etc. (generically referred to as a “processing location”). One form of typical refuse collection vehicle is referred to as a “front loader” or “front-end loader” (FEL), since collection containers are raised from the front end of the collection vehicle. For example, the collection vehicle may be provided with a pair of parallel forks and a lifting mechanism extending from the front of the vehicle. In service, the forks are aligned with channels on a collection bin (i.e., dumpster). The lifting mechanism and forks lift the bin overhead, then invert the bin to empty its contents into a hopper, often disposed immediately behind the driver's cab of the collection vehicle. A plunger (e.g., a hydraulic ram) then pushes the waste toward the back of the vehicle to compact it and make room for the next load. At the processing location the compacted waste may then be forced out of an openable gate at the rear of the vehicle for processing or further transfer.

Apart from manual separation of recyclables at the point of collection, no processing or separation of the collected waste is performed prior to handling at a processing location. Waste is simply collected and compacted, then delivered for subsequent processing.

For known refuse vehicles, the hopper and compaction mechanism are bolted or even welded to the chassis of the vehicle itself or form an integral part of the collection container carried by the vehicle. The hopper and compaction mechanism are generally not readily removable from the collection vehicle, and generally not interchangeable with similar or different functioning systems, other than for repair or replacement of these components.

In certain transfer dump truck designs a secondary container (i.e., an aggregate container or B box) is configured to be removably disposed within a primary container (i.e., the container fixedly attached to the truck itself). The secondary container is often transported on a trailer behind the truck. The secondary container is carried by the trailer on rails, permitting the secondary container to slide from the trailer into the empty primary container on the dump truck. In use, once the contents of the primary container are “dumped” by the lifting mechanism of the truck, the secondary container may be slid into the primary contain and its contents dumped by the lifting mechanism of the truck. These vehicles simply receive, transport and off-load material deposited into the primary and secondary containers. No processing of any deposited material is performed.

Primary food product waste recycling systems are being developed and improved. See for example co-pending U.S. patent application Ser. No. 13/835,081, titled “System for Processing Primary Food Product Waste into Secondary Food Product”, incorporated herein by reference. These systems receive primary food product waste and convert it into secondary food product such as animal feed. Efficient operation of such recycling systems is enhanced by some pre-processing of the primary food product waste, a relatively continuous supply of primary food product waste, environmentally considerate transportation of the primary food product waste to the recycling system, prevention of introduction of contaminants into the primary food product waste during transport, and so on.

### SUMMARY

Accordingly, the present disclosure is directed to aspects of a waste processing system addressing a number of shortfalls of existing waste processing and transport systems. More specifically, disclosed is a waste processing system, comprising: a container having an input end and an opposing output end; a first trough, disposed within the container and oriented in parallel with a longitudinal axis of the container; a first auger, disposed within the first trough and oriented in parallel with the longitudinal axis of the container, wherein the first auger has a first center height and a first overall height; a second trough, disposed within the container adjacent to the first trough and oriented in parallel with the longitudinal axis of the container; a second auger, disposed within the second trough and oriented in parallel with the longitudinal axis of the container, wherein the second auger has a second center height and a second overall height; a dividing wall formed along an intersection of central walls of the first trough and the second trough, wherein the dividing wall has a dividing wall height; and an input chute located at the input end and configured to receive waste material and deposit the waste material onto the first auger and the second auger.

Further disclosed is the waste processing system further comprising a first recirculation chute configured to transfer waste material arriving at the output end back onto the first auger.

Further disclosed is the waste processing system further comprising a second recirculation chute configured to transfer waste material arriving at the output end back onto the second auger.

Further disclosed is the waste processing system further comprising an exit chute located at the output end and configured to expel waste material from the container, wherein the exit chute is configured to have an increasing cross section.

Still further described is a waste processing system, comprising: a container having an input end and an opposing output end; a first trough, disposed within the container and oriented in parallel with the longitudinal axis; a first auger, disposed within the first trough and oriented in parallel with the longitudinal axis of the container, wherein the first auger has a first center height and a first overall height; a second trough, disposed within the container adjacent to the first trough and oriented in parallel with the longitudinal axis of the container; a second auger, disposed within the second trough and oriented in parallel with the longitudinal axis, wherein the second auger has a second center height and a second overall height; a dividing wall formed along an intersection of central walls of the first trough and the second trough, wherein the dividing wall has a dividing wall height; an input chute located at the input end and configured to receive waste material and deposit the waste material onto the first auger and the second auger; a recirculation chute configured to transfer waste material arriving at the output end back on to the first auger; and a drive motor assembly configured to rotate the first auger and the second auger.

### BRIEF DESCRIPTION OF DRAWINGS

In the drawings appended hereto like reference numerals denote like elements between the various drawings. While illustrative, the drawings are not drawn to scale. In the drawings:

FIG. 1 is a side view of a collection and processing container configured for removable disposition within a refuse collection vehicle according to one embodiment of the present disclosure.

FIG. 2 is an end view of a collection and processing container configured for removable disposition within a refuse collection vehicle according to the embodiment illustrated in FIG. 1.

FIG. 3 is a top view of a separation floor as disposed within the interior region of a collection and processing container according to one embodiment of the present disclosure.

FIG. 4 is an illustration of a collection and processing container removably disposed within a refuse collection vehicle according to one embodiment of the present disclosure.

FIG. 5 is an end view of a collection and processing container configured for removable disposition within a refuse collection vehicle according to another embodiment of the present disclosure.

FIG. 6 is a side view of a collection and processing container configured for removable disposition within a refuse collection vehicle according to the embodiment illustrated in FIG. 5.

FIG. 7A illustrates a side cutaway view of a waste processing system, in accordance with one embodiment.

FIG. 7B illustrates a top view of the waste processing system, in accordance with one embodiment.

FIG. 8A illustrates a cross-section view of the waste processing system, configured to include a first exemplary structure for a dividing wall, in accordance with one embodiment.

FIG. 8B illustrates a cross-section view of the waste processing system, configured to include a second exemplary structure for a dividing wall, in accordance with one embodiment.

FIG. 8C illustrates a cross-section view of the waste processing system, configured to include a third exemplary structure for a dividing wall, in accordance with one embodiment.

FIG. 9A illustrates a side cutaway view of the waste processing system, configured to expel waste material through an exit chute, in accordance with one embodiment.

FIG. 9B illustrates a side cutaway view of the waste processing system, configured to expel waste material through a down output port, in accordance with one embodiment.

FIG. 9C illustrates a side cutaway view of the waste processing system, configured to expel waste material through a rear output port, in accordance with one embodiment.

### DETAILED DESCRIPTION

We initially point out that description of well-known starting materials, processing techniques, components, equipment and other well-known details may merely be summarized or are omitted so as not to unnecessarily obscure the details of the present disclosure. Thus, where details are otherwise well known, we leave it to the application of the present disclosure to suggest or dictate choices relating to those details.

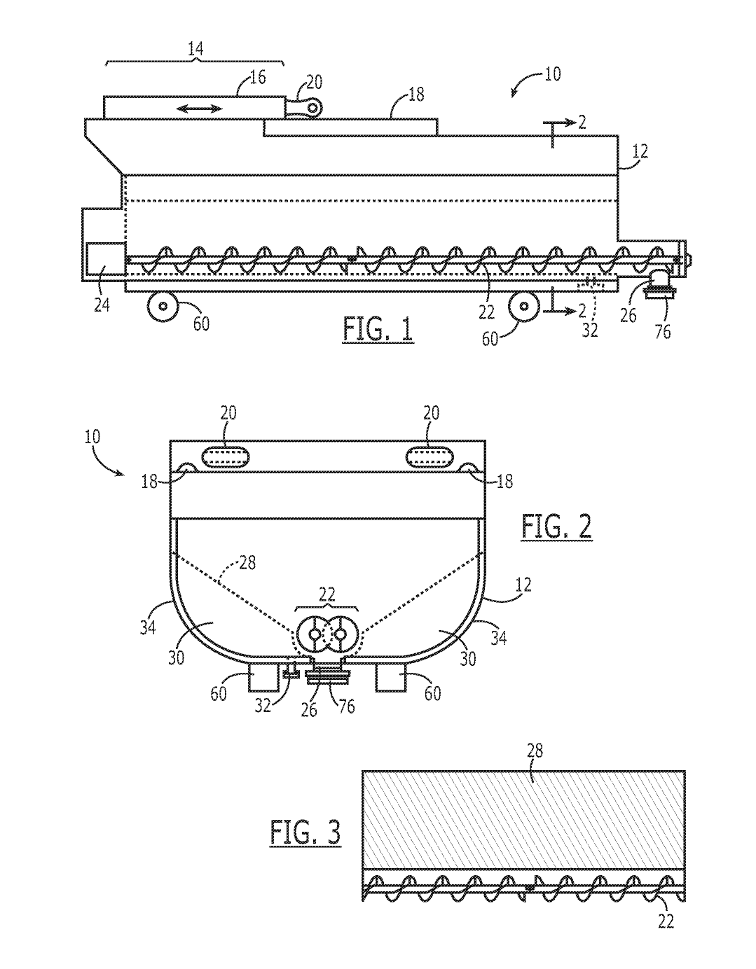

We refer first to FIGS. 1 and 2, which illustrate a side-view and an end-view of a collection and processing container 10, respectively, configured for removable disposition within a refuse collection vehicle according to one embodiment of the present disclosure. Container 10 comprises a shell 12, formed for example from steel or other high-strength, corrosion resistant material. As will be explained further below, container 10 is shaped and configured to fit within the envelope of a refuse collection vehicle, such as one having at least portions of its hopper and compactor removed. Container 10 has a first, or proximal, end at which is formed a material-input opening 14 for receiving product from, for example, a front loading refuse collection vehicle. The location of this opening corresponds to the chute into which refuse is deposited by the truck, for example immediately behind the driver cab, by way of lifting and inverting of a dumpster as otherwise known.

A cover 16 is provided for sealable containing of the material deposited into container 10 through opening 14. Cover 16 is provided with a sliding mechanism, such as runners 18, to provide surfaces of reduce friction, and hence reduced required power, to open and close cover 16. According to one embodiment, cover 16 may be in a first or closed position. Cover 16 may be moved to a second position which fully or partially opens opening 14 in conjunction with the lifting and inverting of a collection bin by the forks of the vehicle. Cover 16 remains closed (in the first position), and the contents of container 12 sealed from the environment thereby, except when the truck's lifting mechanism is positioned to dump contents from a collection bin into container 10. Engagement mechanisms 20 may operatively connect to elements of the vehicle to coordinate opening of cover 16 with operation of the truck's lifting mechanism. Sealing of container 12 effectively keeps primary food product waste separated from the general environment in order to keep odor to a minimum, minimize attraction of insect, rodents, and other vectors, and in order to minimize contamination of the primary food product waste during transport. Alternatively, cover 16 may remain open during the collection phase, and may be closed at some other phase, such as a transportation phase, or a staging phase prior to processing of the contents thereof. During any staging and subsequent transfer of food product waste from container 10 to a food product recycling system, cover 16 may remain closed so that the holding and delivery takes place separated from the general environment.

Container 12 may be provided with one or more screw augurs or other working and transfer mechanism 22 for working and transferring of material deposited therein. In embodiments in which working and transfer mechanism 22 comprise a rotating member (such as a screw auger or augers), a motor 24 may be provided to drive the mechanism. Alternatives to augers, such as hydraulic rams, expandable bladders, and other forms of working and transfer mechanism contemplated hereby may be driven by some other appropriate mechanism, not shown but contemplated herein. Working and transfer mechanism 22 may serve at least two functions. First, food product waste may be worked while the product is in transit from the pickup location to the staging or processing location. “Working” of the product in this context includes, but is not limited to, separating constituent elements of the product, reducing the physical size (e.g., chopping, crushing, milling, and/or filtering) of constituent elements of the product, and so on, and comprises more than merely compressing of the product. Second, food product waste may be transferred from within container 10 to a material-output port 26 configured to be connected to other elements of a processing system.

According to one embodiment of the present disclosure, container 10 is provided with at least one downward sloping interior separation floor 28, configured to converge proximate working and transfer mechanism 22. An example of separation floor 28 is illustrated in FIG. 3. Separation floor(s) 28 are formed to be or to include screens or openings, sized and configured such that liquid constituents of food product waste may preferentially be filtered out of the product waste within container 10. Gravity screening alone through separation floors 28 may separate liquid from the food product waste deposited into container 10. One or more of agitation of product waste within container 10 during transport, accumulated weight of the product waste within container 10, and/or working of the product waste by working and transfer mechanism 22 may further assist with extraction of liquid from the product waste. The liquid is accumulated within one or more liquid holding reservoirs 30 disposed between external walls 34 of container 10 and separation floors 28. An output port 32 is provided for draining the reservoir(s) 30, such as at a processing location.

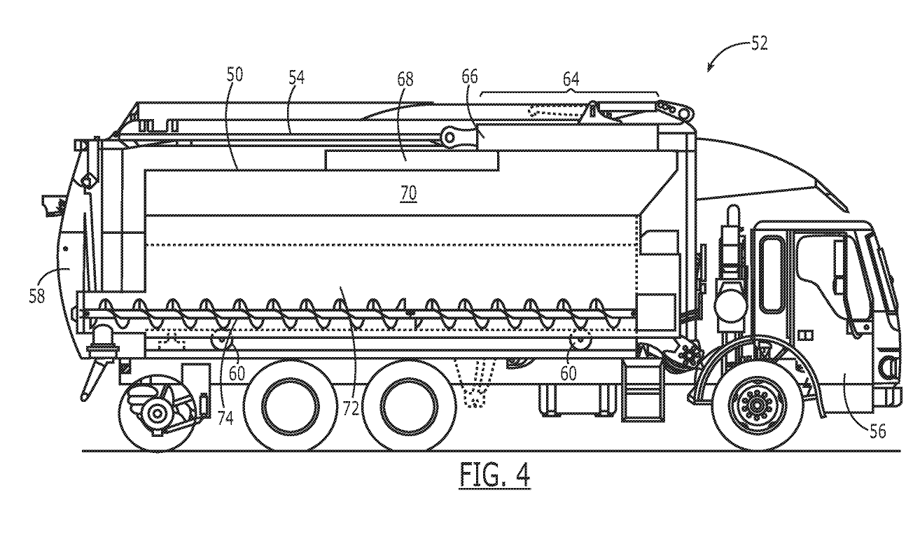

With reference to FIG. 4, one embodiment of a collection and processing container 50 is shown disposed within the envelope of a refuse collection vehicle 52. An “envelope” of vehicle 52 as used herein is intended to mean the space interior to a body or housing 54 (excluding cab 56) carried by the vehicle, as opposed for example to open space such as where no body or housing is present. Often this is a space in which waste is collected and in which a compactor is disposed for compacting the waste. In certain embodiments, at least portions of the compactor (and other internal equipment and attachments) may be removed from the body or housing in order to accommodate container 50, while in other embodiments container 50 is sized and shaped to accommodate items remaining within the envelope.

Refuse collection vehicle 52 includes an openable rear gate 58 that is typically used for removal of compacted waste. Collection and processing container 50 is of a shape and size, and otherwise configured to removably slide into the envelope of refuse collection vehicle 52 through open rear gate 58, although in certain embodiments gate 58 may not be present or be removed to accommodate container 50. With reference also to FIGS. 1 and 2, wheels (or skids) 60 may be provided to permit the sliding insertion of collection and processing container 50 within vehicle 52 such that resistance is minimized, and fittings such as ports 26 and 32 do not impeded insertion or removal of container 50 and are not damaged while container 50 is inserted or removed.

In one example of operation, vehicle 52 has disposed within its envelope container 50. Vehicle 52 may be a front-end loader (FEL) type collection vehicle. At various collection sites specific food product waste is collected in collection bins (i.e., dumpsters). Sources of food product waste may be restaurants, food production or processing facilities, public areas (e.g., with signage such that the public is alerted that the bin is for a specific waste type only), etc. Vehicle 52 lifts and inverts the bin for emptying as is standard for a front-end loader. Cover 66 over opening 64 in the top of container 50 slides open as the bin is lifted and positioned for dumping to allow product to be dumped from the collection bin into the interior 70 of container 50. Once within interior 70, liquid from the waste may be collected in reservoirs 72 located at the bottom and sides of container 50 for later recycling or disposal. Working and transfer mechanism 74 works the waste within interior 70, for example to further extract liquid, chop and compress the waste, and so on. The liquid extraction and waste processing within interior 70 may take place while vehicle 52 is in transit, for example to subsequent collection locations or to a staging or processing location. During any transit time, cover 64 may be closed such that the contents within interior 70 are effectively isolated from the general environment outside of container 50.

At certain times, such as during loading and transport of container 50, a cover 76 (or other sealing mechanism such as a gate, etc.) may be place over the opening of port 26 (illustrated in FIGS. 1 and 2). While in place, cover 76 prevents food product waste from exiting through port 26. In certain embodiments, the presence of cover 76, and hence the stopping of food product waste from exiting port 26, causes working and transfer mechanism 74 to perform primarily a working function. When removed, working and transfer mechanism 74 performs primarily a transfer function, transferring food product to a receptacle or facility external to container 50.

Once interior 70 is full, the last collection location has been serviced, or the food product waste in interior 70 is otherwise to be delivered to a selected staging and/or processing location, vehicle 52 proceeds to said staging and/or processing location. At the staging and/or processing location container 50 may be off-loaded from vehicle 52, and optionally an empty container (not shown) is loaded into vehicle 52 in place of container 50. Port 26 (FIGS. 1 and 2) may be connected to a corresponding receiving port of a food product waste recycling system such as disclosed in the aforementioned U.S. application Ser. No. 13/835,081. Food product waste may then be transferred in a sealed fashion from container 50 to the recycling system for additional processing, description of which is beyond the scope of the present disclosure.

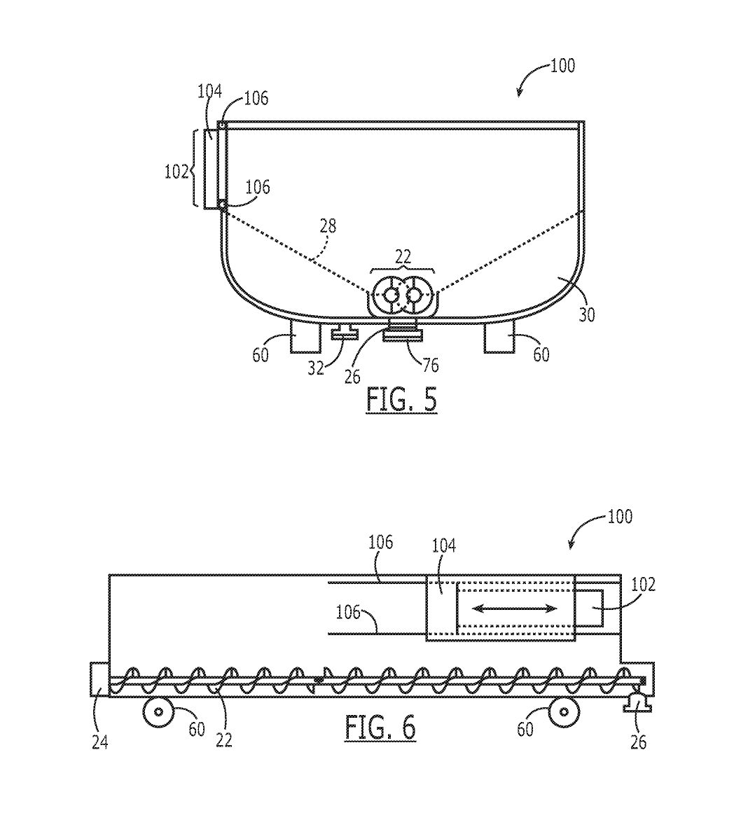

In some instances, referring again to FIG. 5, waste material has been known to ride on top of the augers of working and transfer mechanism 22. Such riding by the waste material is referred to herein as “bridging” because the waste material forms a bridge across the tops of the augers rather than moving down into the augers to be worked by the augers. Such bridging phenomenon can be exacerbated when waste material has been placed into bags (e.g., paper, plastic, etc.) for temporary storage and transfer prior to being loaded into a waste processing system. An embodiment of a waste processing system as disclosed herein comprises two or more working and transfer mechanisms, each comprising an auger disposed in a trough located adjacent to each other with a dividing wall therebetween in such a configuration that addresses this potential bridging problem.

An auger, also referred to as a screw auger or rotatable screw auger, is a mechanical subsystem known in the art to include a helical screw blade having a perimeter edge. The perimeter edge is formed along an outermost perimeter of the helical screw blade and serves as a primary contact region between the auger and an associated trough configured to at least partially encompass the auger. The auger is typically coupled to a drive shaft to supply rotational energy. In certain configurations, the drive shaft runs at least a portion of the longitudinal extent of the helical screw blade. In various embodiments described herein, two or more augers operate to work and transfer the waste material from the input end towards an output end of the waste processing system. In certain embodiments, the augers operate independently within respective, adjacent troughs. The waste material is worked by the augers. For example, as a given auger rotates waste material is crushed and shredded between the outer edge and corresponding interior trough surface.

In one embodiment, a recirculation chute at the output end is configured to redirect flowing waste material back onto the augers. The recirculation chute provides a path for the waste material to be worked multiple times by the augers to further work the waste material.

The dividing wall is located between each adjacent auger, longitudinally dividing the waste material flow between troughs. In one embodiment, the dividing wall is at least as tall as the axis of rotation of each auger but not taller than the height of the auger relative to an inside base surface of the troughs. The dividing wall directs the flow of processed waste material into the troughs and onto the respective augers thereby reducing or disrupting the formation of bridges that may tend to form as waste material is added.

In one embodiment, the waste processing system comprises two adjacent augers, each having generally the same overall dimensions. Each auger is configured to rotate within a respective trough when driven by a drive motor assembly. In one embodiment, the drive motor assembly is disposed at the input end and the augers are coupled through a bearing assembly to the drive motor assembly. The rotation and weight of the augers serve to work the waste material as the waste material is transferred by the augers. In certain embodiments, the augers rotate without a bearing at the output end, allowing processed waste material to flow freely and unobstructed as it exits the output end. In other embodiments, a second bearing is located at the output end to provide support and/or stability for the auger as it rotates. Alternatively, the second bearing is located at an intermediate location between the input end and the output end. In certain embodiments, waste material is driven to exit the waste processing system through an exit chute located at the output end. In one embodiment, the recirculation chute is configured to provide a recirculation path while in a first position, and to act as the exit chute when maneuvered to a second, exit chute position. In other embodiments, waste material is driven to exit instead through an output port disposed at the output end. Further details describing various embodiments are discussed elsewhere herein.

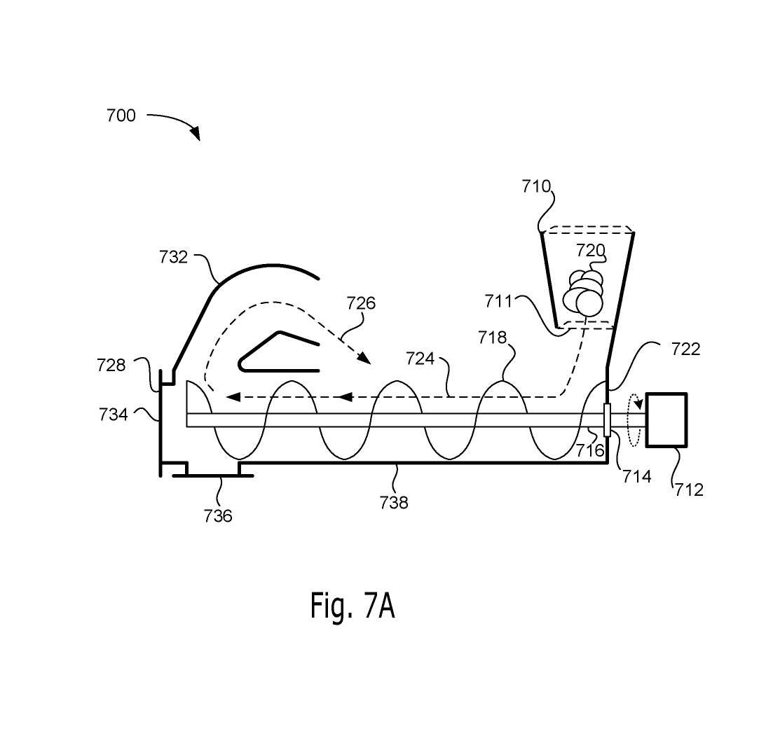

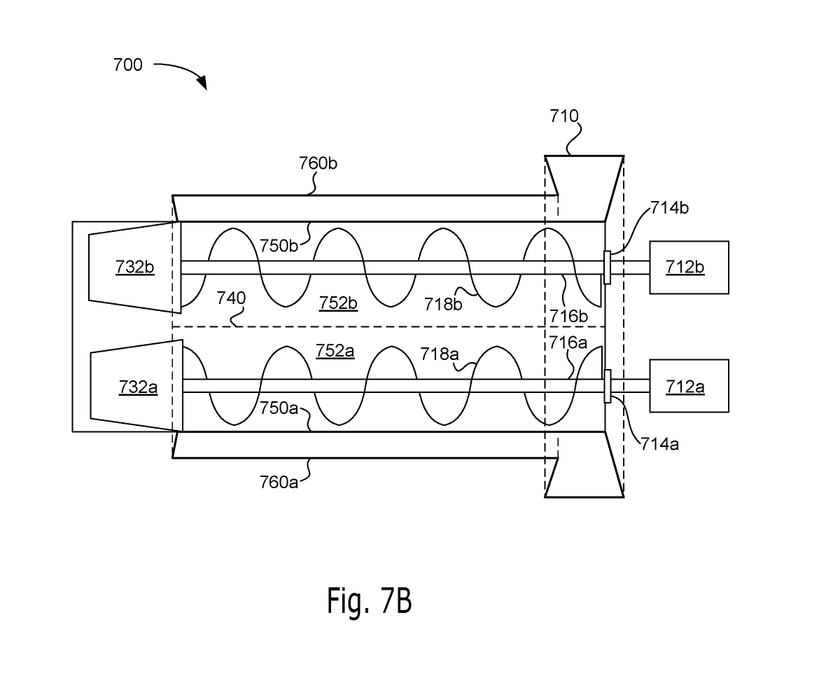

FIG. 7A illustrates a side cutaway view of a waste processing system 700, in accordance with one embodiment. As shown, waste processing system 700 comprises an input chute 710, an auger 718 coupled to a drive shaft 716, a drive motor assembly 712, a container 738, and a recirculation chute 732. Input chute 710 is disposed at an input end 722 of waste processing system 700, and recirculation chute 732 is disposed at an output end 728. As shown, input end 722 and output end 728 correspond to opposing ends of container 738 along a longitudinal axis of container 738.

Input chute 710 is configured to receive input waste material 720 and pass the input waste material through an input port 711, to deposit the input waste material onto auger 718 for processing. Drive motor assembly 712 causes drive shaft 716 to rotate, causing auger 718 to rotate and slice, crush, and otherwise break input waste material 720 into progressively smaller fragments of waste material while the waste material is pushed along material path 724. Waste material arriving at output end 728 is pushed up and through recirculation chute 732 where it follows recirculation path 726 to be deposited onto auger 718 at a location between input end 722 and output end 728. In one embodiment, recirculation chute 732 is configured to have a generally increasing cross section along recirculation path 726. The increasing cross section provides space for waste material to expand and flow freely without obstruction along recirculation path 726. Any potential clumps of waste material traveling along recirculation path 726 may flow and expand freely within the increasing cross section without creating an obstruction. In one embodiment, recirculation chute 732 is fabricated to include smooth, curvilinear internal surfaces that are generally free of protruding surface features that may hinder unobstructed flow of waste material. Recirculation of the waste material back onto auger 718 generally results in the waste material having smaller overall fragment sizes. For example, as a given cluster of fragmented waste material is processed by auger 718, fragments within the cluster are crushed and broken down into smaller fragments by auger 718. Each successive pass results in successively finer fragments.

As input waste material 720 is progressively worked, the waste material begins to behave as a viscous liquid and consequently flows essentially as a liquid along material path 724 and recirculation path 726.

In one embodiment, container 738 is configured to enclose waste material being processed as well as various system components of waste processing system 700 that contact the waste material. Container 738 may include, without limitation, a down output hatch 736, a rear output hatch 734, and/or a side output hatch (not shown). Down output hatch 736 may be opened to allow waste material to exit container 738 along a downward exit path. Rear output hatch 734 may be opened to allow waste material to exit container 738 along a rearward exit path that is a continuation of material path 724. The side output port may be opened to allow waste material to exit container 738 along a side path (not shown). In certain embodiments, container 738 is configured to include additional structures for mounting or otherwise coupling waste processing system 700 to a truck or a fixed foundation. During a waste collection process, the truck transports waste processing system 700 to collection sites, where input waste material 720 is added to container 738.

In one embodiment, drive shaft 716 is supported by a bearing assembly 714 at input end 722. Drive motor assembly 712 is configured to rotate the auger 718 in a first rotational direction (e.g., clockwise) to transfer waste material from input end 722 towards output end 728. In certain embodiments, drive motor assembly 712 is also configured to rotate the auger 718 in an opposite rotational direction (e.g., counterclockwise) to transfer the waste material from output end 728 towards input end 722. In certain implementations where waste processing system 700 is mounted to a truck and configured to transfer waste material between output end 728 and input end 722 to advantageously provide better weight distribution along material path 124 and between different axles of the truck.

While only one auger 718 is shown in the present side cutaway view, two or more augers 718 are implemented within waste processing system 700. Furthermore, container 738 includes one trough per auger 718, with each auger 718 disposed longitudinally within a corresponding trough. In one embodiment, container 738 comprises container 10 of FIGS. 1-2, and opening 14 is disposed above input chute 710.

FIG. 7B illustrates a top view of waste processing system 700, in accordance with one embodiment. As shown, waste processing system 700 includes augers 718a and 718b, coupled to respective drive motor assemblies 712a and 712b. A recirculation chute 732a is configured to provide a recirculation path from the output end of auger 718a back onto auger 718a. Similarly, a recirculation chute 732b is configured to provide a recirculation path from the output end of auger 718b back onto auger 718b. In one embodiment, input chute 710 is configured to deposit input waste material 720 onto augers 718a and 718b.

Auger 718a is disposed within a first trough 752a and auger 718b is disposed within a second trough 752b. Trough 752a is constructed to include trough wall 750a and trough 752b is constructed to include trough wall 750b. Central, adjacent walls of troughs 752a and 752b are configured to intersect thereby forming a dividing wall 740 that is aligned along a longitudinal path between trough 752a and trough 752b. Dividing wall 740 separates waste material between troughs 752a and 752b, resulting in waste material transfer patterns that tends to disrupt any bridging by input waste material 720. A first containment wall 760a located along an outer wall of trough 752a and a second containment wall 760b located along an outer wall of trough 752b together provide additional vertical height for containing waste material being processed in troughs 752.

In one embodiment, drive motor assemblies 712a and 712b are configured to generate independent rotational velocities on drive shafts 716a and 716b. In one operating mode, the independent rotational velocities are generally the same and provide the same waste material transfer velocity within troughs 752a and 752b. In a different operating mode, the independent rotational velocities are different and provide different waste material transfer velocities between trough 752a and trough 752b. Drive motor assemblies 712 may be implemented using any technically feasible techniques to generate and couple rotational energy onto drive shafts 716a and 716b.

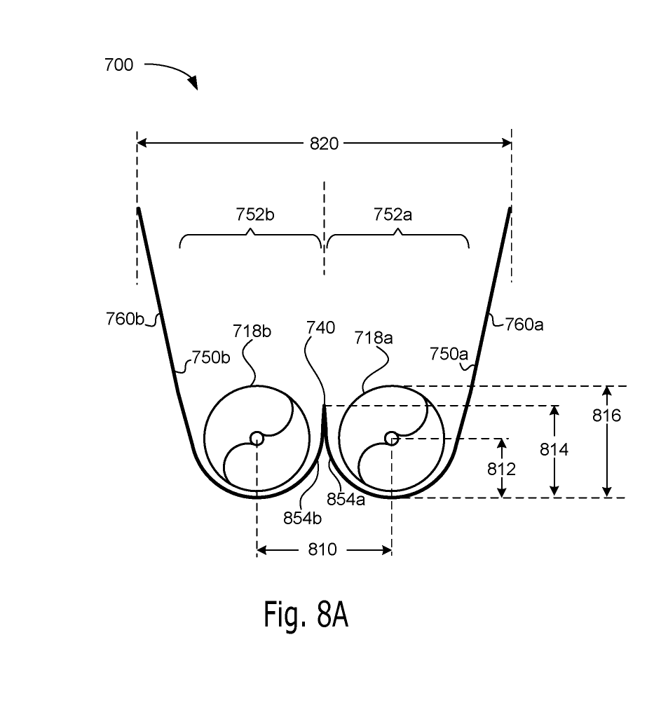

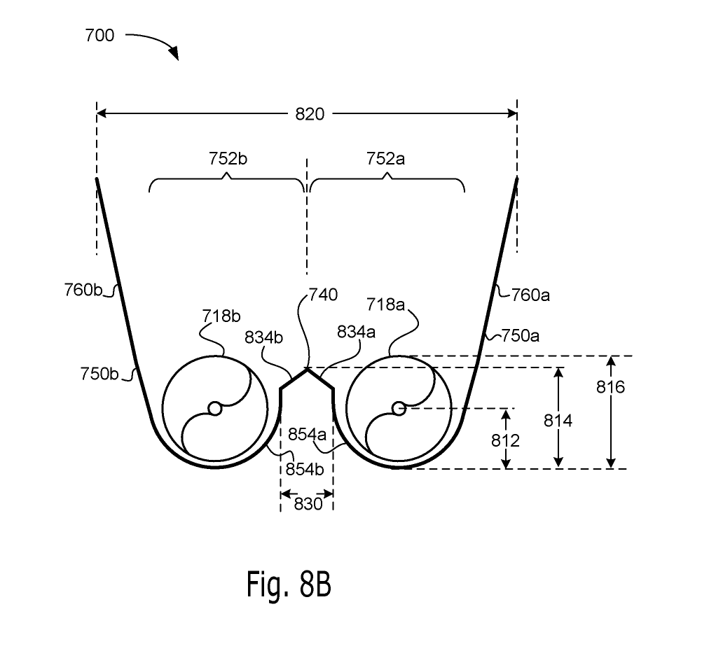

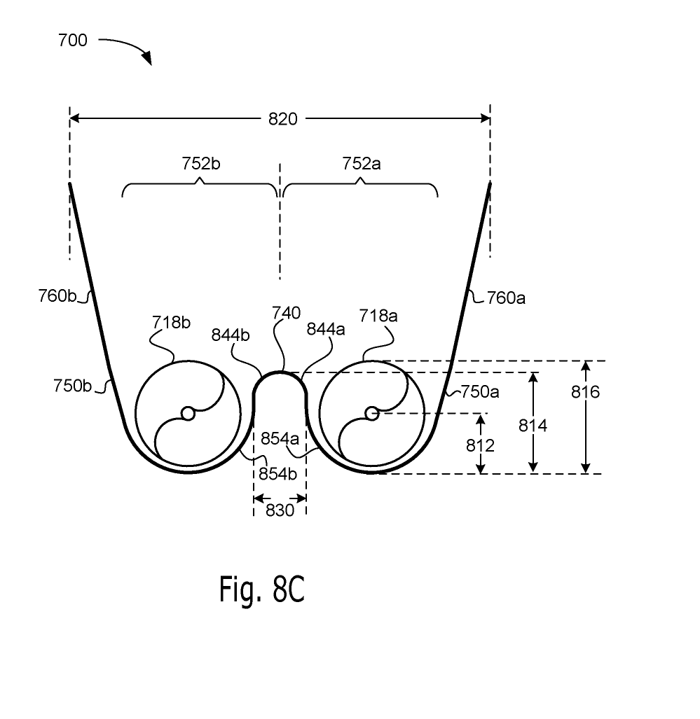

FIG. 8A illustrates a cross-section view of waste processing system 700 configured to include a first exemplary structure for dividing wall 740, in accordance with one embodiment. As shown, the first exemplary structure of dividing wall 740 is formed by joining a central wall 854a of trough 752a and a central wall 854b of trough 752b. In one embodiment, central walls 854 are fabricated from one or more structural segments.

A distance 810 separates a center axis of rotation for auger 718a from a center axis of rotation for auger 718b. The center axis of rotation for auger 718a is located a center height 812 above an inside base surface of trough 752a. In one embodiment, the center axis of rotation for auger 718b is also located center height 812 above an inside base surface of trough 752b. As shown, augers 718 have an overall auger height 816 above inside base surfaces of their respective trough 752.

As shown, dividing wall 740 has a dividing wall height 814 above the inside base surface of troughs 752. In one embodiment, dividing wall height 814 is greater than or equal to center height 812. In some embodiments, dividing wall height 814 is less than or equal to overall auger height 816.

Waste processing system 700 has an overall width 820, which may be specified to conform to appropriate regional truck dimension regulations. For example, in one embodiment width 820 is specified to be less than or equal to ninety-six inches (or, with one exception, less than or equal to one hundred and two inches) to conform to certain North American road and transportation standards. In one embodiment with a seventy-two inch overall width 820, each auger is configured to be sixteen inches or more in diameter, but with a small enough diameter to accommodate a given configuration of dividing wall 740. Furthermore, in certain embodiments, a one-half inch clearance is provided between the perimeter edge of each auger 718 and each corresponding trough wall 750 at the input end. In one embodiment, containment walls 760a and 760b slope inward to form a “V” shape, as shown. For example, in certain embodiments the width of each trough 752 is less than half the overall width 820, and containment walls 760 are configured to slope inward to meet with corresponding trough walls 750. In alternative embodiments, troughs 752 are wider, and containment walls 760 are both vertically oriented and constructed to form a “U” shape. In one embodiment, input chute 710 is fabricated to have width 820, thereby facilitating convenient and rapid input of waste material 720.

FIG. 8B illustrates a cross-section view of waste processing system 700 configured to include a second exemplary structure for dividing wall 740, in accordance with one embodiment. As shown, central wall 854a includes a flat segment 834a, and central wall 854b includes a flat segment 834b. Thus, the second exemplary structure for dividing wall 740 is formed by the intersection of flat segment 834a of central wall 854a and flat segment 834b of central wall 854b forming a tent-like structure. In one embodiment, flat segments 834 are oriented at a sufficiently steep angle to cause waste material to fall into an associated trough 752.

FIG. 8C illustrates a cross-section view of the waste processing system configured to include a third exemplary structure for dividing wall 740, in accordance with one embodiment. As shown, central wall 854a includes a curved segment 844a, and central wall 854b includes a curved segment 844b. Thus, the third exemplary structure for dividing wall 740 is formed by the intersection of curved segment 844a of central wall 854a and curved segment 844b of central wall 854b intersecting to form a curvilinear structure. In one embodiment, curved segments 844 comprise a semicircular cross-section.

It is to be understood that the particular shape of dividing wall 740 is not limited by the particular examples of FIGS. 8A, 8B and 8C, but rather, can be any shape that serves to separate waste material between, and direct waste material onto, the respective troughs thereby addressing or preventing any bridging that might otherwise occur. In other words, while certain specific cross-section configurations for dividing wall 740 are illustrated herein, any configuration that allows waste material to be drawn by gravity into the troughs and onto one or more augers 718 is within the scope and spirit of the embodiments of the present system.

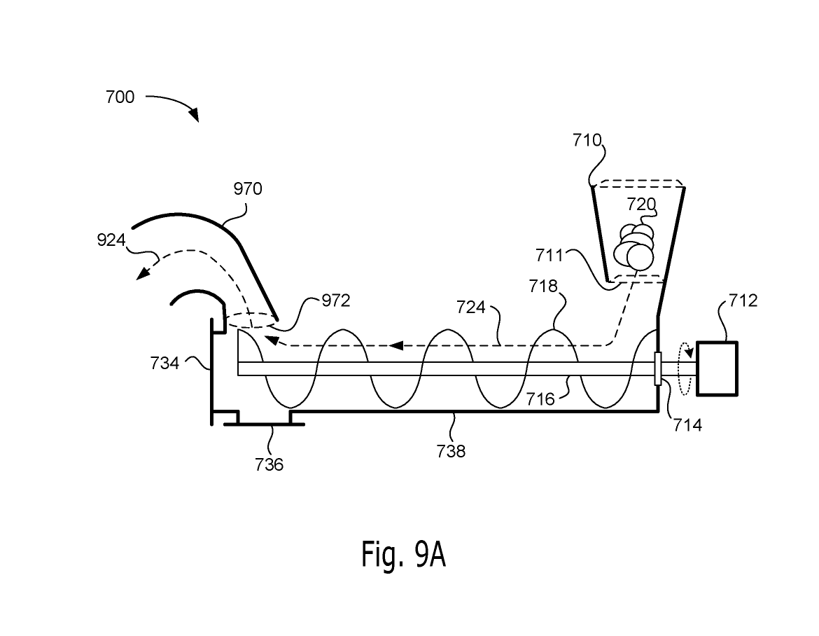

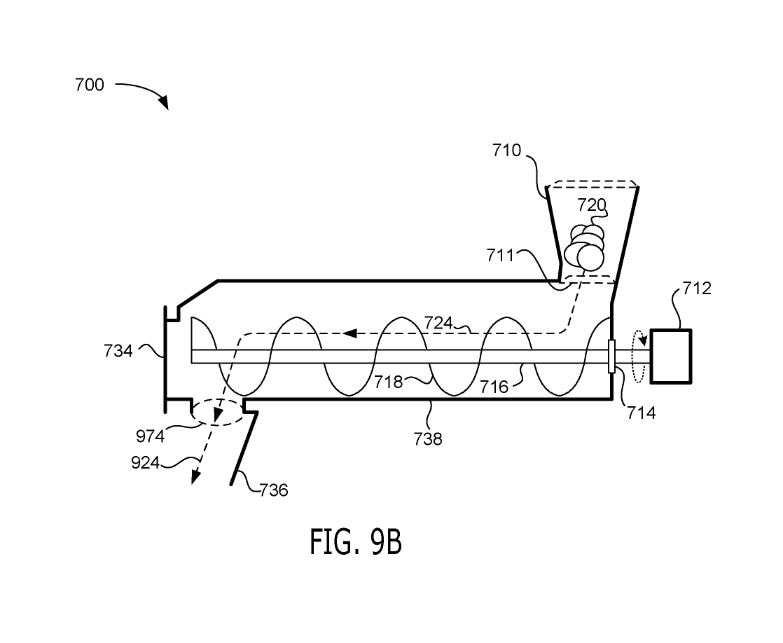

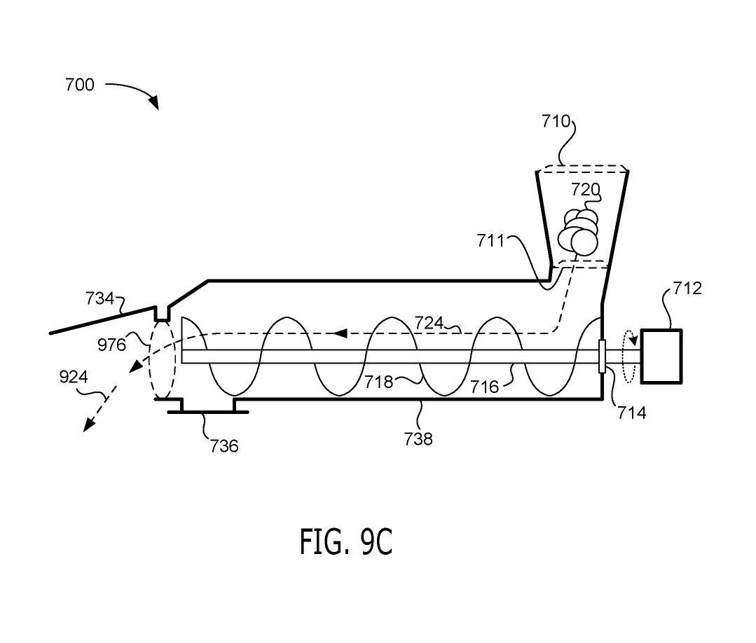

FIG. 9A illustrates a side cutaway view of waste processing system 700 configured to expel waste material through an exit chute 970, in accordance with one embodiment. The waste material is transferred along material path 724 and continues along exit path 924 through output port 972 and exit chute 970. In one embodiment, exit chute 970 is configured to have a generally increasing cross section along exit path 924. The increasing cross section provides space for waste material to expand and transfer freely without obstruction along exit path 924. Any potential clumps of waste material traveling along exit path 924 may transfer and expand freely within the increasing cross section without creating an obstruction. In one embodiment, exit chute 970 is fabricated to include smooth, curvilinear internal surfaces that are generally free of protruding surface features that may hinder unobstructed transfer of waste material.

In one embodiment, exit chute 970 is removably coupled to waste processing system 700. In alternative embodiments, exit chute 970 comprises one or more recirculation chute 732, each configured to operate in either a recirculation mode as described by reference to FIGS. 7A-7B, or in an exit mode for expelling waste material from waste processing system 700.

FIG. 9B illustrates a side cutaway view of waste processing system 700 configured to expel waste material through a down output port 974, in accordance with one embodiment. As shown, down output port 974 provides exit path 924 for expelling waste material from waste processing system 700 when down output hatch 736 is open. In this configuration, the expelling process may be assisted, at least in part, by gravity.

FIG. 9C illustrates a side cutaway view of waste processing system 700 configured to expel waste material through a rear output port 976, in accordance with one embodiment. As shown, rear output port 976 provides an exit path 924 for expelling waste material from waste processing system 700 when rear output hatch 734 is open. In this configuration, the expelling process may be assisted, at least in part, by gravity.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

The descriptions above have assumed that the vehicle in use is a front-end loading collection vehicle, with the container having a sealable top opening. However, other arrangements are contemplated herein. For example, with reference to FIGS. 5 and 6, a side-loading container 100, with many of the aforementioned features and components, may form an alternate embodiment. In place of a top opening, container 100 comprises an opening 102 in one side thereof. A cover 104 may be provided, which travels on slides 106, for example under control of a side-load mechanism of a refuse transport vehicle. Some or all of the elements disclosed above may be present, and may operate in a fashion similar to that disclosed above.

Similarly, while one opening is disclosed in the embodiments above, containers with two or more openings are within the scope of the present disclosure. Those openings may be on the same or different surfaces of the container, depending on the particular implementation of the present disclosure. Each of the multiple openings has a corresponding cover to maintain isolation of the contents of the container from the general environment. Opening and closing of the covers may be coordinated or independent, again depending on the particular implementation.

Furthermore, it has been assumed above that the cover for the food product waste container operates under automatic control of a loading mechanism of a transport vehicle. However, operation of the cover in any of the embodiments disclosed herein may be manual or semi-automatic in the sense that a worker may engage an opening mechanism and a bin emptying mechanism separately, with or without powered assistance.

It will be understood that the description and illustration of the location of elements of the various embodiments above is by way of example only, and that variations in the number, position, orientation, size, and so on of such elements and the container itself are within the scope of the present disclosure. Further, while various elements and features of a collection and processing container have been disclosed, the addition of further elements and features is contemplated herein. For example, additional mechanisms for assisting with the separation of liquid from food product waste by separation floors 28 (FIGS. 1 and 2) may be provided within the container, mechanisms to assist with loading and unloading of the container from a refuse collection vehicle may be provided on or associated with the container, access ports, working and transfer mechanism release means, and so on may be provided depending upon the specific implementation of the present disclosure.

Therefore, while examples and variations have been presented in the foregoing description, it should be understood that a vast number of variations exist, and the above examples are merely representative, and are not intended to limit the scope, applicability or configuration of the disclosure in any way. Various of the above-disclosed and other features and functions, or alternative thereof, may be desirably combined into many other different systems or applications. Various presently unforeseen or unanticipated alternatives, modifications variations, or improvements therein or thereon may be subsequently made by those skilled in the art which are also intended to be encompassed by the claims, below.

Therefore, the foregoing description provides those of ordinary skill in the art with a convenient guide for implementation of the disclosure, and contemplates that various changes in the functions and arrangements of the described examples may be made without departing from the spirit and scope of the disclosure defined by the claims thereto.

What is claimed is:

1. A waste processing system, comprising:
a container having an input end and an opposing output end;
a first trough, disposed within the container and oriented in parallel with a longitudinal axis of the container;
a first auger, disposed within the first trough and oriented in parallel with the longitudinal axis of the container, wherein the first auger has a first center height and a first overall height;
a second trough, disposed within the container adjacent to the first trough and oriented in parallel with the longitudinal axis of the container;
a second auger, disposed within the second trough and oriented in parallel with the longitudinal axis of the container, wherein the second auger has a second center height and a second overall height;
a dividing wall formed along an intersection of central walls of the first trough and the second trough, wherein the dividing wall has a dividing wall height; and
an input chute located at the input end and configured to receive waste material and deposit the waste material onto the first auger and the second auger.

2. The waste processing system of claim 1, wherein the dividing wall height is greater than the first center height and is less than the first overall height.

3. The waste processing system of claim 1, wherein the second center height is equal to the first center height and the second overall height is equal to the first overall height.

4. The waste processing system of claim 1, further comprising a drive motor assembly configured to rotate the first auger and the second auger.

5. The waste processing system of claim 4, wherein the first auger and the second auger are rotated by the drive motor assembly to work and transfer the waste material from the input end to the output end.

6. The waste processing system of claim 4, wherein the first auger and the second auger are rotated by the drive motor assembly to work and transfer the waste material from the output end to the input end.

7. The waste processing system of claim 4, wherein the first auger and the second auger are rotated by the drive motor assembly at the same rotational velocity.

8. The waste processing system of claim 4, wherein the first auger and the second auger are rotated by the drive motor assembly at a different rotational velocity.

9. The waste processing system of claim 1, further comprising a first recirculation chute configured to transfer waste material arriving at the output end back onto the first auger.

10. The waste processing system of claim 9, further comprising a second recirculation chute configured to transfer waste material arriving at the output end back onto the second auger.

11. The waste processing system of claim 9, wherein the first recirculation chute is further configured to expel waste material from the container.

12. The waste processing system of claim 9, wherein the first recirculation chute is configured to have an increasing cross section.

13. The waste processing system of claim 1, further comprising an exit chute located at the output end and configured to expel waste material from the container, wherein the exit chute is configured to have an increasing cross section.

14. The waste processing system of claim 1, wherein the dividing wall formed along an intersection of central walls of the first trough and the second trough is comprised of a curved segment of the central wall of the first trough and a curved segment of the central wall of the second trough intersecting to form a curvilinear structure.

15. The waste processing system of claim 1, wherein the dividing wall formed along an intersection of central walls of the first trough and the second trough is comprised of a flat segment of the central wall of the first trough and a flat segment of the central wall of the second trough intersecting to form a tent-like structure.

16. A waste processing system, comprising:
a container having an input end and an opposing output end;
a first trough, disposed within the container and oriented in parallel with the longitudinal axis;
a first auger, disposed within the first trough and oriented in parallel with the longitudinal axis of the container, wherein the first auger has a first center height and a first overall height;
a second trough, disposed within the container adjacent to the first trough and oriented in parallel with the longitudinal axis of the container;
a second auger, disposed within the second trough and oriented in parallel with the longitudinal axis, wherein the second auger has a second center height and a second overall height;
a dividing wall formed along an intersection of central walls of the first trough and the second trough, wherein the dividing wall has a dividing wall height;
an input chute located at the input end and configured to receive waste material and deposit the waste material onto the first auger and the second auger;
a recirculation chute configured to transfer waste material arriving at the output end back on to the first auger; and
a drive motor assembly configured to rotate the first auger and the second auger.

17. The waste processing system of claim 16, wherein the dividing wall height is greater than the first center height and the dividing wall height is less than the first overall height.

18. The waste processing system of claim 16, wherein the first auger and the second auger are rotated by the drive motor assembly to transfer the waste material from the input end to the output end.

19. The waste processing system of claim 16, wherein the recirculation chute is configured to have an increasing cross section.

20. The waste processing system of claim 16, further comprising an exit chute located at the output end and configured to expel waste material from the container, wherein the exit chute is configured to have an increasing cross section.
